(19) United States
(12) Patent Application Publication
(10) Pub. No.: US 2007/0226765 A1
(43) Pub. Date: Sep. 27, 2007

(54) Managing Blackout of Media Content

(75) Inventors: Thomas J. Bahnck, Conshohocken, PA (US); Arthur P. Jost, Mount Laurel, NJ (US); Robert E. Mack, Collegeville, PA (US); Lawrence D. Vince, Lansdale, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(73) Assignee: GENERAL INSTRUMENT CORPORATION, Horsham, PA (US)

(21) Appl. No.: 11/614,327

(22) Filed: Dec. 21, 2006

Related U.S. Application Data
(60) Provisional application No. 60/785,645, filed on Mar. 24, 2006.

(51) Int. Cl. G06F 17/00

(52) U.S. Cl. 725/63

(57) ABSTRACT

A method and system for managing a blackout of media content data includes receiving a media content stream at a local media content device. The media content stream includes the media content data and blackout data related to the blackout of the media content data. The local media content device is operable to implement the blackout of the media content data with the blackout data in the media content stream.

### RELATED APPLICATION

This application claims priority to U.S. Provisional Patent Application Ser. No. 60/785,645, filed on Mar. 24, 2006, the disclosure of which is incorporated herein by reference in its entirety.

### BACKGROUND

Today, programmers, such as, the Entertainment and Sports Programming Network (ESPN)® and the Turner Broadcasting System (TBS)®, manage the blackout of media content, such as, televised sporting events. That is, programmers determine when media content will and will not be aired in certain media markets. Programmers currently provision blackouts by sending de-authorization commands to access control processors in specific integrated receiver decoders (IRDs) in order to prevent the media content from entering multiple service operator (MSO) networks. The programmers oftentimes signal substitute media content to be aired through out-of-band messaging, which IRDs receive and to which IRDs automatically switch. Alternatively, MSOs manually provision substitute media content for the duration of the blackout period. Traditionally, MSOs have carried IRDs in individual, local hubs, also referred to as local head-ends, thereby giving the programmers the granularity necessary to blackout media content only for the appropriate localities.

However, the current trend in the MSO/telecommunication companies is to receive the satellite signal containing the media content at a central hub, or super head-end. The super head-end typically transmits the media content to MSOs over terrestrial internet protocol (IP) distribution networks. By circumventing the IRDs at the local head-ends, the MSOs reduce their costs, but undermine the programmers' ability to control blackouts.

Additionally, the MSOs require control mechanisms for syndication blackout when multiple programmers provide identical media content to a given area, and the programmers without local broadcasting rights must be blacked out. In these instances, the MSOs must manually remove the media content without local broadcasting rights for the duration of the program.

Currently, there are three forms of provisioning blackout: 1) regional blackout, 2) circular blackout, and 3) spotbeam blackout.

Regional blackout involves assigning each IRD one or more of 256 different geographic identification (ID) codes, corresponding to different geographic regions. When each IRD receives a program authorization message, the IRD compares the authorized regions to the IRD's assigned geographic ID code. If the IRD's geographic ID code matches an authorized region, then the IRD grants access to the transmission of the media content.

Circular blackout involves provisioning each IRD for a geographic location consisting of three coordinates (x, y, and z), designating a location on the earth's surface. The IRD receives a set of circular blackout regions in a proprietary message prior to the start of a program. If a program is identified as subject to circular blackout, and the IRD's geographic location is within the set of circular blackout regions or equal thereto, the IRD is de-authorized from transmitting the media content. A blackout message banner may be transmitted in place of the program.

Spotbeam blackout involves provisioning each IRD for a geographic location in the same way as circular blackout. However, the geographic location is interpreted as an authorized area rather than a de-authorized area. The IRD receives a flag for the media content indicating that the blackout is intended to be interpreted as spotbeam. If the IRD's geographic location is outside of the indicated area, the media content is blacked out.

Each of the three current blackout methods depends on the MSOs to use one or more IRDs to receive programming for each blackout region. This system requires that authorization messages be sent in secure messages that can only be processed by a secure processor associated with each IRD. Thus, by centralizing satellite reception and removing the correlation between IRDs and blackout regions, the MSOs undermine the programmers' ability to control blackout of media content to specific regions. Programmers typically will not allow the MSOs to de-authorize blacked-out content and provision substitute content themselves. Moreover, it is extremely labor intensive for the MSOs to manually provision substitute content.

Going forward, both programmers and MSOs will need equal ability to provision blackout, without reliance on IRDs as the authorization mechanism. Programmers need to maintain autonomy over their media content, while MSOs must have the ability to provision syndication blackout and any future applications of blackout. Moreover, because IRDs are increasingly being circumvented, programmers are losing the granularity they need to effectively provision blackout at the local level.

### BRIEF DESCRIPTION OF THE DRAWINGS

Various features of the embodiments described in the following detailed description can be more fully appreciated when considered with reference to the accompanying figures, wherein the same numbers refer to the same elements.

FIG. 1 illustrates a conventional media content distribution network;

FIG. 2 illustrates a flow chart showing the transmission of the media content stream in the conventional media content distribution network of FIG. 1;

FIG. 3 depicts a media content distribution network for distributing blackout data;

FIG. 4 depicts a flow chart showing the transmission of the media content stream in the media content distribution network of FIG. 3;

FIG. 5 depicts a block diagram of a local head-end processing a media content stream;

FIG. 6 depicts a flowchart of a method for processing blackout data in a media content stream; and

FIG. 7 depicts a block diagram of a computing platform configured to implement various examples disclosed herein.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the embodiments.

According to an example, a method and system described herein allows for managing blackout of media content data. Media content data may include audio, video, textual data, or any combination thereof. For example, media content data may include televised sporting events, television programs, movies, radio programs, etc. Blackout of media content occurs when a broadcaster of the media content prevents presentation of the media content to at least one broadcast region. More particularly, for instance, a television program may be blacked-out in a certain geographic location or market, such that the television program is not presented to that geographic location or market.

In a first example, the program may be blacked-out because a broadcaster may lack the legal rights to air the television program in the geographic location or market. In this example, the media content may be transmitted, but encoded or scrambled, such that it cannot be viewed by, or otherwise presented to, a user. In another example, the media content may not be transmitted to the specific geographical location or market at all. However, in contrast to video on-demand (VOD) applications, a user cannot request to have the blacked-out media content presented to the user because the broadcaster of the media content lacks the legal authority to present the media content to the user.

According to an example described herein, blackouts may be managed by inserting blackout data directly into a media content stream. The media content stream includes a plurality of elementary streams carrying media content data, such as video, audio, ancillary data, and combinations thereof. The media content stream may include the actual media content data, such as MPEG data, data used for routing or transmitting the media content stream, etc. For example, a typical media content stream for a movie or television program includes at least an elementary stream carrying video data and an elementary stream carrying audio data.

The blackout data may be inserted directly into the media content stream by embedding blackout data in its own elementary stream and assigning a unique packet identification (PID) number to the blackout data elementary stream. In this manner, a programmer-controlled IRD is not required to process the blackout data. The blackout data may pass through the IRD with the media content to be processed by any reasonably suitable device. For example, the blackout data may be processed by a modulator, such as a Smartstream Encryptor Modulator (SEM), at the local head-end or at a set-top box (STB). To render a device suitable to process blackout data inserted into the media content stream may only requires a software upgrade to the device. Thus, by inserting the blackout data directly into the media content stream as described herein, blackout data may be processed by any suitable device, instead of relying strictly on programmer-controlled IRDs.

The blackout data that may be inserted into the media content stream includes any data used to limit the presentation of media content data and/or any data used to substitute the presentation of other media content data for the blacked-out media content data. For instance, the blackout data may include geographical information, media content identifiers (IDs), timing information, etc.

The geographical information may include any information indicating any regions that media content is to be blacked-out and may include zip codes, area codes, DMA zones, etc. Moreover, while the geographical information may denote physical locations, the geographical information may also include any other information or codes indicating how a blackout should be implemented, including the identification of a particular subset of end users. Blackout data may further include blackout descriptors, sub-descriptors, a unique ID for a blackout epoch, the length of the original service ID, an original service ID, a revision flag indicating that indicating that a blackout descriptor revises a previously signaled blackout epoch, etc.

Media content IDs may be any data or descriptor tending to identify media content data. For example, a media content ID may be an alias for a television program that is intended to be substituted for a televised sporting event. Media content IDs may be used to access a database or directory to obtain the media content data and/or additional data related to the media content data, as will be described in greater detail below.

Timing information may include any information describing when and the duration the media content data will be blacked-out and information describing when and the duration the other media content data will be substituted for the blacked-out media content data. For instance, timing information may include a start time for blacking-out a program and an end time for lifting the blackout of a program, as well as start and end times for substituting another program for the blacked-out program.

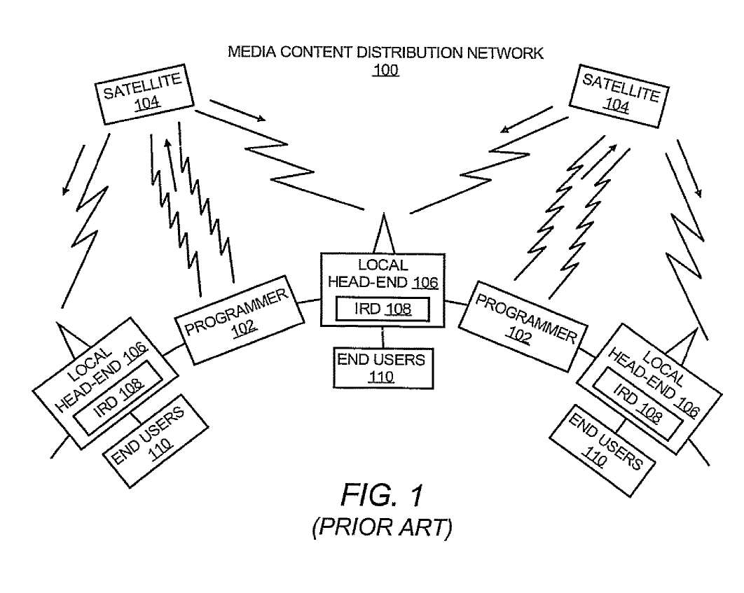

FIG. 1 depicts an example of a conventional media content distribution network 100. The media content distribution network 100 includes programmers 102, each of which may be any entity that provides media content. For example, the programmers 102 may include the Entertainment and Sports Programming Network (ESPN)®, which creates media content by televising sporting events and developing television programs, movies, etc. Similarly, the Turner Broadcasting System (TBS)®, is another example of a programmer, which also broadcasts media content, such as television programs, sporting events, and movies.

The programmers 102 transmit respective media content streams to satellites 104, as is known in the art. The satellites 104 transmit the media content streams to local head-ends 106. The term “local head-end”, as used herein, encompasses any entity that receives a media content stream and transmits the media content stream to end-users or subscribers. In this regard, the local head-ends 106 may, for instance, be multiple service operator (MSO) networks, which include, for example, local cable companies, such as Verizon®, Cox®, Comcast®, etc., and satellite media companies, such as DirecTV®, Dish Network®, etc. The local head-ends 106 include integrated receiver decoder (IRD) satellite receivers 108, which are devices used to receive media content streams transmitted from the satellites 104. The IRDs 108 are controlled by programmers 102 to blackout media content and, in certain instances, to substitute new media content in place of the blacked-out media content. Therefore, the only way to control the blackout of media content in the conventional media content distribution network 100 is by programming each individual IRD 108.

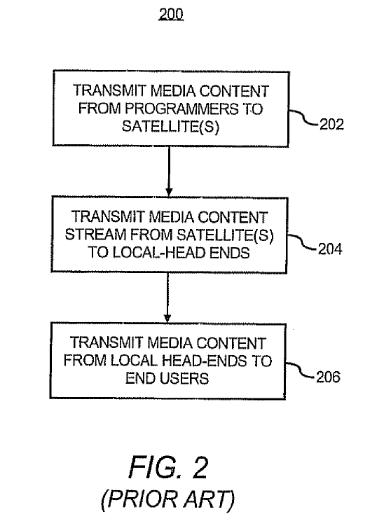

FIG. 2 depicts a flow chart 200 showing the transmission of the media content streams in the media content distribution network 100 depicted in FIG. 1. At step 202, the programmers 102 transmit the media content streams to one or more satellites 104. At step 204, a media content stream is transmitted from the satellites 104 to the local head-ends 106. At step 206, the local head-ends 106 transmit the media content stream to end users 110, such as cable or satellite television subscribers.

As discussed above, the media content distribution network 100 allows programmers to control the blackout of media content only at the IRD 108 level. The presence of IRDs 108 at multiple geographic locations, each receiving the media content stream, provides programmers 102 with the granularity required for provisioning blackout on a regional basis according to the authorization granted to individual MSOs at different localities.

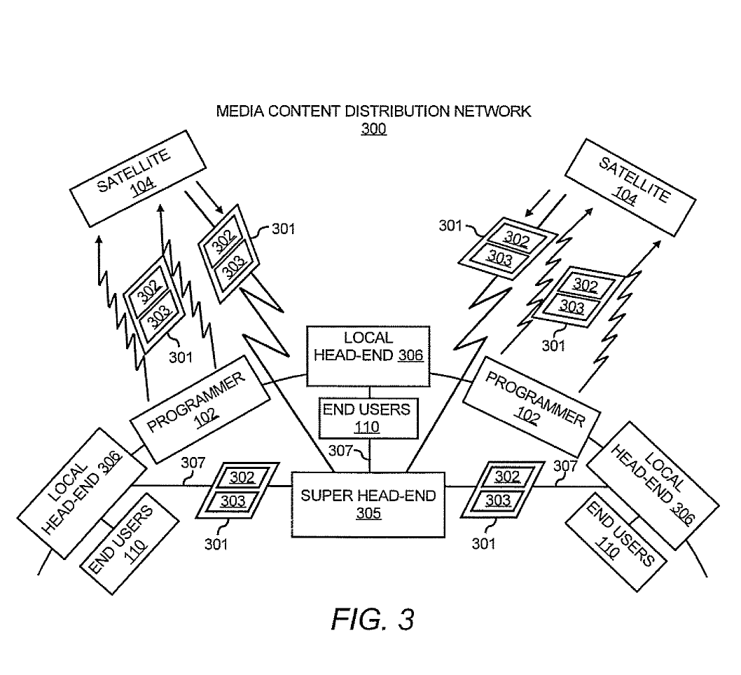

FIG. 3 depicts an illustrative media content distribution network 300. The media content distribution network 300 includes programmers 102 configured to transmit media content streams 301 to one or more satellites 104, substantially as described above with respect to FIGS. 1 and 2. However, in the media content distribution network 300, the satellites 104 may transmit the media content stream 301 to a super head-end 305 and the media content stream 301 may include both blackout data 303 and media content data 302.

The super head-end 305 may be any entity which receives a media content stream 301 and transmits the media content stream 301 to a plurality of local head-ends 306. In addition, the super head-end 305 may transmit the media content stream 301 to the local head-ends 306 by any method known in the art, such as a terrestrial internet protocol (IP) network, optical distribution network, etc. The transmission from the super head-end 305 to the local head-ends 106 is depicted in FIG. 3 as lines 307.

The local head-ends 306 may be substantially similar to or different from the local head-ends 106, depicted in FIG. 1. For example, the local head-ends 306 may not contain the IRDs 108 depicted in FIG. 1, because the local head-ends 306 may not receive a satellite signal. For instance, the local head-ends 306 may receive media content via an IP or fiber optic network from the super head-end 305, rather than directly from the satellites 104. However, in another example, the local head-ends 306 may contain IRDs and receive satellite signals sent either directly from the satellites 104 or from the super head-end 305. The local head-end 306 may also contain equipment capable of processing blackout data 303 carried in the media content stream 301.

The blackout data 303 may be inserted into the media content stream 301 at any point in the media content distribution network 300. For example, a broadcaster may insert the blackout data into the media content stream 301 in an MPEG encoder at the uplink. However, a person having ordinary skill in the art will appreciate that MPEG may not always be the video format or transport for the media content stream 301, and that other video formats may be used.

The blackout data 303 may also be inserted into the media content stream 301 at the local head-end 306. The blackout data 303 is then only carried to subscribers that require the blackout data 303, and the volume of blackout data 303 traversing the local head-end network may be kept to a minimum.

Table 1, below, represents an example of blackout data 303, which may be carried in an elementary stream within the media content stream 301.

TABLE 1
Blackout data
Blackout Subdescriptor

| Syntax | Bits | Bytes | Mnemonic | Notes | Example Value |
|---|---|---|---|---|---|
| blackout_sudescriptor { | | | | | |
| blackoutSudescLength (B) | 64 | 8 | uimsbf | Length in bytes of this blackout | 38 |
| | | | | definition. | |
| blackoutID | 16 | 2 | uimsbf | Uniquely identifies this blackout | 100 |
| | | | | epoch. 0 if unknown or not used. | |
| region_subdescriptor() | | | | | |
| cancelFlag | 1 | 0.125 | bslbf | Indicates that this blackout | 0 |
| | | | | descriptor cancels a previously | |
| | | | | declared blackout epoch. | |
| if (cancelFlag) { | | | | | |
| origServiceIDlength | 8 | 1 | uimsbf | Signifies number of characters | 8 |
| | | | | (bytes) in the original service ID. | |
| origServiceID | 2040 | 255 | bslbf | States the original service ID to | espn.com |
| | | | | which this applies. This field is | |
| | | | | required if blackoutID is zero. | |
| } else { | | | | | |
| revisionFlag | 1 | 0.125 | bslbf | Indicates that this blackout | 0 |
| | | | | descriptor revises a previously | |
| | | | | declared blackout epoch. | |
| startTime | 64 | 8 | uimsbf | UTC | 16:00:00 (in UTC) |
| duration | 64 | 8 | uimsbf | Milliseconds. 0 if not used | 12600000 |
| | | | | (endTime used instead). | |
| endTime | 64 | 8 | uimsbf | UTC. End time may optionally be | 16:00:00 (in UTC) |
| | | | | declared instead of duration. | |
| substituteServiceIDlength | 8 | 1 | uimsbf | Signifies number of characters | 14 |
| | | | | (bytes) in the service ID. | |
| substituteServiceID | 2040 | 255 | uimsbf | Variable length, (0–255). | espn.com.espn-alt-1 |
| } | | | | | |
| } | | | | | |
| Total | 4370 | 546.3 | | | |

The blackout data 303 may be transmitted through the media content distribution network 300 continually throughout the blackout of media content data 301. For example, the blackout data 303 may be transmitted every few seconds or more. Downstream devices will continually listen to blackout data 303 that arrives, such that, if blackout is extended there will be an updated timing information in the blackout data 303. Similarly, a broadcaster will be able to cancel a blackout early by setting cancellation data in the blackout data 303, in the event that a blackout is to be terminated early.

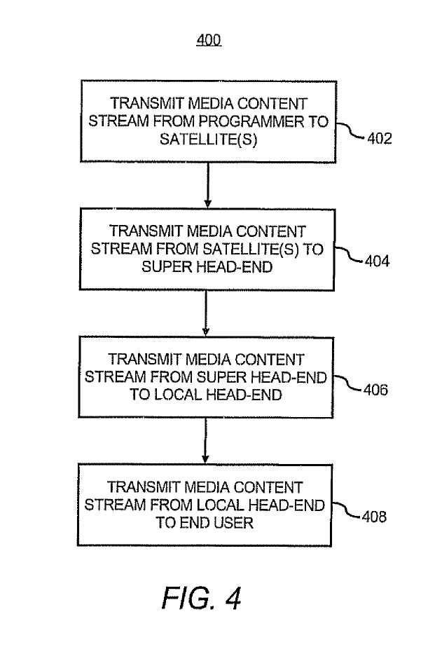

FIG. 4 depicts an illustrative flow chart of a method 400 showing the transmission of the media content stream 301 in the media content distribution network 300, depicted in FIG. 3, according to an example. It is to be understood that the following description of the method 400 represents a generalized illustration and that other steps may be added or existing steps may be removed, modified or rearranged without departing from a scope of the method 400.

At step 402, programmers 102 may transmit the media content stream 301, which contains both the media content data 302 and the blackout data 303, to one or more satellites 104, substantially as set forth above. At step 404, the media content stream 301 may be transmitted from the one or more satellites 104 to the super head-end 305. At step 406, the super head-end 305 may transmit the media content stream 301 to the local head-ends 106. At step 408, the local head-ends 106 may transmit the media content stream 301 to end users 110, substantially as set forth above. While FIGS. 3 and 4 depict the programmers 102 transmitting the media content stream 301 to the super head-end 305 via the satellites 104, a person having ordinary skill in the art will appreciate that the super-head end 305 may receive the media content stream 301 by any other reasonably suitable method, such as over a terrestrial network.

Generally speaking, use of the super head-end 305 in the media content distribution network 300 circumvents the IRDs 108 at the local head-ends 306 and, thus, programmers 102 lose the ability to control blackout at a regional level. Therefore, according to the examples described herein, blackout data 303 may be inserted into the media content stream 301, such that IRDs 108 are not required to manage blackouts. For example, the audio and video data of a media content stream 301 may include MPEG data for a televised football game and the blackout data may be added to ancillary data of the media content stream 301.

The blackout data 303 may be inserted into the media content stream 301 at any of a number of different stages in the media content distribution network 300. For example, the programmers 102 may insert blackout data 303 into the media content stream 301 before it is transmitted to the super head-end 305. Alternatively, the blackout data 303 may be inserted into the media content stream 301 at the super head-end 305, at the local head-ends 306, or at any point in the media content distribution network 300, for example.

The media content stream 301 carrying the media content data 302 and the blackout data 303 may be transmitted to a plurality of local head-ends 306 through the media distribution network 300 along the path described in FIG. 3. However, a person having ordinary skill in the art will appreciate that the local head-ends 306 may receive the media content stream 301 through the media content distribution network 100 described in FIGS. 1 and 2, directly from a programmer 102, from a programmer 102 via the super head-end 305 without the use of the satellites 104, or in any other reasonably suitable manner.

Although, not specifically illustrated in FIG. 4, the blackout data 303 may be processed in the method 400 as it is transmitted. The blackout data 303 may also be processed at a plurality of different locations by a plurality of different devices, as described in greater detail below.

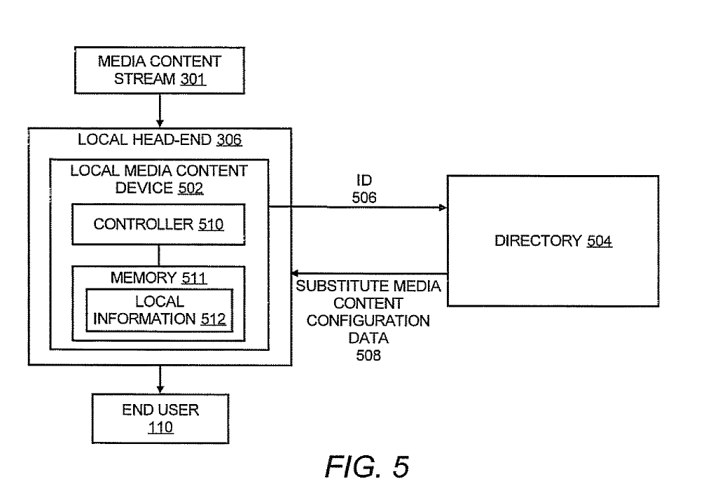

FIG. 5 depicts an illustrative block diagram of a local head-end 306 configured to process a media content stream 301. The local head-end 306 includes a local media content device 502, which may be any reasonably suitable hardware, software, or combination thereof, capable of processing blackout data 303 contained in a media content stream 301. For example, the local media content device 502 may be an edge decoder, a modulator, an encoder, such as the Smartstream Encryptor Modulator (SEM), splicers, groomers, ad splicers, etc. The local media content device 502 may include one of or any reasonably suitable combination of the above-mentioned devices.

As shown, the local media content device 502 includes a controller 510 and a memory 511. The controller 510 may be software, hardware, or any combination of software and hardware operable to process blackout data 303. The memory 511 may be any form of data storage known in the art and may contain local information 512. As discussed below, the controller 510 may compare the blackout data 303 with the location information 512 to determine whether a program is to be blacked out.

The controller 510 may process the blackout data 303 from the media content stream 301 through any reasonably suitable steps required to determine if the blackout data 303 applies to the local media content device 306, implement the blackout of the media content data 302, and determine and retrieve substitute media content configuration data 508 and substitute media content to transmit in lieu of the blacked-out media content data 302. To determine if the blackout data 303 applies to the local media content device 502, the local media content device 502 may perform a process of comparing codes or geographic information in the blackout data to the local information 512 associated with the local media content device 502.

In this regard, the local information 512 may include codes or geographic information assigned to the local media content device 502. For example, the local media content device 502 may be assigned to a specific geographic region or may be assigned a particular code or series of codes. The local media device 502 may compare its assigned codes or regions to the geographic information contained in the blackout data 303. If the information does not match, the blackout data 303 does not apply to the local media content device 502 and the local media content device 502 is, therefore, authorized to transmit the media content data 302 in the media content stream 301. Conversely, however, if the blackout data 303 matches the local information 512 of the local media content device 52, the local media content device 502 is configured to apply the blackout data 303 by blacking-out the media content data 302 in the media content stream 301.

Implementing the blackout data 303 may include determining timing information from the blackout data 303. The timing information may include start times, end times, durational times, etc., to apply in blacking-out the media content data 302. Using the timing information, the local media content device 502 may not transmit or may cease transmitting the media content data 302 during the determined times. Therefore, the media content data 302 may be blacked-out throughout the duration indicated by the timing information.

In an example, substitute media content may be transmitted to end users 110 in lieu of the blacked-out media content data 302. To transmit substitute media content, the local media content device 502 may determine and retrieve substitute media content configuration data 508. In one example, the blackout data 303 may include a media content ID 506, which may identify the substitute media content. In this example, the local media content device 502 may query a directory 504 with the media content ID 506. The information returned from the directory 504 to the local media content device 502 may include substitute media content configuration data 508, such as multicast IP address, UDP port, MPEG service number, etc. The local media content device 502 may use the substitute media content configuration data 508 to ‘join’ the stream of substitute media content for the duration of the blackout event. The stream of substitute media content may be broadcast from the programmer, processed by IRDs, and made available on the MSO's distribution network along with the primary stream. For example, the substitute media content for ESPN® may be ESPNEWS®. The directory 504 may give the local media content device 504 the substitute media content configuration data 508, and timing information, necessary to find the substitute stream and switch it in for the correct period of time.

The directory 504 may be located either in the local head-end 306 and/or the super head-end 305. For example, the directory 504 may include local directories in the local head-ends 306 for localized streams (for instance, the American Broadcasting Network (ABC)® for Philadelphia) and regional or national directories in the super head-end 305 for national streams (for instance, ESPN®). The regional/national and local directories of the directory 504 may be linked together via a service similar to the domain name system (DNS) for the Internet. This would allow a local media content device 502 to obtain media content information for a national stream with the following sequence of events: (1) The local media content device 502 queries the local directory for national media content information; (2) the local directory queries the national directory for national media content information; (3) the national directory returns the national media content information to the local directory; and (4) the local directory returns the national media content information to the local media content device 502. The local media content device 502, the directory 504, and the process described above may include a Multicast Address Discovery (MCAD) system, which is described in U.S. patent application Ser. No. 11/288,797, filed Nov. 29, 2005, which is incorporated by reference herein in its entirety.

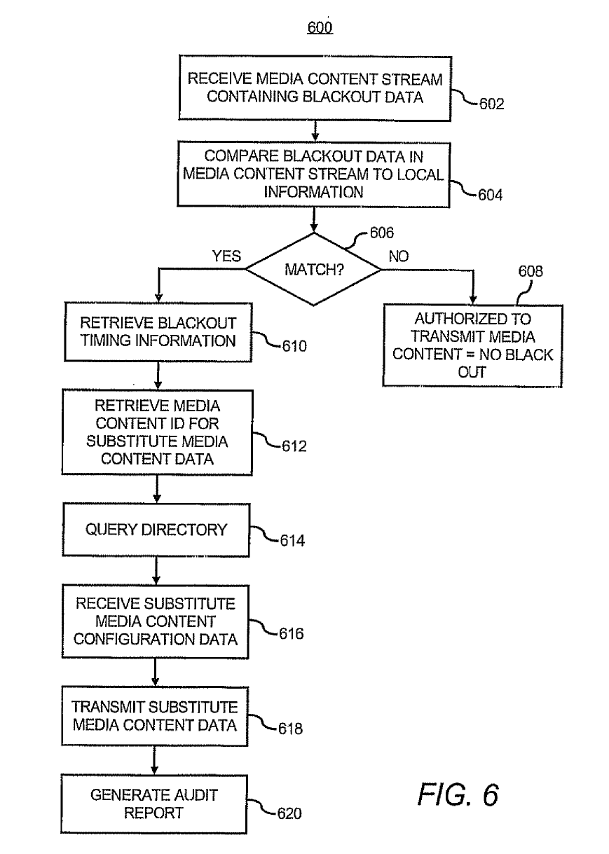

FIG. 6 depicts an illustrative flowchart of a method 600 for processing blackout data 303 in a media content stream 301. The method 600 is described with respect to the media content distribution system 300 illustrated in FIG. 3 and the block diagram illustrated in FIG. 5 by way of example and not of limitation. It should be understood that the method 600 represents a generalized illustration and that other steps may be added or existing steps may be removed, modified, or rearranged without departing from a scope of the method 600.

At step 602, a media content stream 301 containing blackout data 303 is received. The media content stream 301 may be received by a local media content device 502. For example, the local media content device 502 may include an edge decoder located at the local head-end 306, which receives a media content stream 301 carrying MPEG data for a televised football game, as well as data for blacking-out the football game in certain geographic locations. In other embodiments, the local media content device 502 may include a STB located at an end user's 110 premises.

At step 604, the blackout data 303 in the media content stream 301 may be compared to local information 512. The local information 512 may include geographical regions or other codes assigned to the local media content device 502. The local information 512 may be compared to geographical information contained in the blackout data 303 to determine if the local information 512 matches the blackout data 303. For example, the local information 512 may include a regional code assigned to the local media content device 502, which may be compared to a regional code contained in the blackout data 303.

At step 606, it is determined whether the local information 512 matches the blackout data 303. If these do not match, at step 608, no blackout is implemented and the media content data 302 may be transmitted by, for example, the local media device 502. Thus, in keeping with the example above, the football game may be transmitted to end users 110 by the local media content device 502.

However, if the local information 512 matches the blackout data 303, timing information from the blackout data 303 may be retrieved at step 610. The match may be, for example, a regional code contained in the blackout data 303 that is equivalent to a regional code assigned to a local media device 502. Because a match is determined, the media content data 302 may not be authorized for transmission by the local media device 502 and, therefore, the blackout may be implemented. Alternatively, however, a blackout of the media content data 302 may be implemented in situations where there is no match, for instance, if the controller 510 is programmed in this manner.

The timing information may be part of the blackout data 303 and may provide the times to start and stop the blackout of the media content data. The timing information may be retrieved by the local media content device 502 from the blackout data 303 and the controller 510 may compare the timing information to an internal clock or other timing mechanism. In the example above, therefore, the local media content device 502 may determine that the football game is to be blacked-out from 4 pm EST to 8 pm EST.

At step 612, the local media device 502 may retrieve a media content ID 506 for substitute media content configuration data 508. By way of example, the media content ID 506 may be contained in the blackout data 303 and may be an alias for substitute media content to be transmitted in lieu of the media content data 302 in the media content stream 301. For example, the media content ID 506 may be an alias for a particular movie or other program.

At step 614, the local media device 502 may query a directory 504 to obtain substitute media content configuration data 508. The substitute media content configuration data 508 may include multicast IP address, UDP port, MPEG service number, etc.

At step 616, the substitute media content configuration data 508 may be received. The local media content device 502 may use the substitute media content configuration data 508 received from the directory 504 to ‘join’ the substitute media content data stream for the duration of the blackout event. The substitute media content data stream may be broadcast from the programmer, processed by IRDs, and made available to the local head-end 306 with the primary stream. The directory 504, the method for querying the directory 504, and the method for receiving substitute media content configuration data 508 may be substantially similar to the system and methods described in U.S. patent application Ser. No. 11/288,797, incorporated by reference above.

At step 618, the local media content device 502 may transmit the substitute media content data 508 to the end users 110. In addition, or alternatively, the substitute media content data 508 may be transmitted to any other device in the media content distribution network 300. In keeping with the example above, for instance, the local media content device 502 may transmit the particular movie associated with the media content ID 506 from 4 pm EST to 8 pm EST to end users 110 in lieu of the televised football game.

At step 620, the local media content device 502 may generate an audit report. An audit report is a record of any blackout related information, including any attempted blackouts, or creation and transmission of blackout information. The audit reports may include any information related to the media content data 302 that was blacked-out, the substitute media content configuration data 508, the substitute media content data, and the times and durations that the blackouts occurred. The audit reports may also include information related to the time and manner in which blackout data 303 was inserted into the media content stream 301, the individual or organization responsible for inserting the blackout data 303 into the media content stream 301, the transmission of the media content stream 301 containing the blackout data 303, etc. The audit reports may be generated by the device which implements the blackout, such as, the local media content device 502, or any other suitable device.

Although not shown in FIG. 6, the method 600 may also include sending, outputting, or storing the audit reports. Sending audit reports includes transmitting audit reports in messages, such as, e-mail, facsimile, etc., through, for instance, a private, encrypted, encoded, etc., messages. For example, when a blackout occurs, an audit report may be generated and transmitted automatically to any entity, such as the programmers 102, the super head-end 305, etc.

Outputting audit reports generally refers to presenting the audit report on a screen, printing, or otherwise providing the audit report in a format that may be readily viewed by a person. The audit reports may also be stored at any suitable location, including, for instance, the local head-end 306. In addition, the audit reports may be sent, output, or stored automatically any time a blackout occurs or periodically, such as, on a pre-defined schedule.

The operations set forth in the method 600 may be contained as a utility, program, or subprogram, in any desired computer accessible medium. In addition, the method 600 may be embodied by a computer program, which can exist in a variety of forms both active and inactive. For example, it can exist as software program(s) comprised of program instructions in source code, object code, executable code or other formats. Any of the above can be embodied on a computer readable medium, which include storage devices and signals, in compressed or uncompressed form.

Exemplary computer readable storage devices include conventional computer system RAM, ROM, EPROM, EEPROM, and magnetic or optical disks or tapes. Exemplary computer readable signals, whether modulated using a carrier or not, are signals that a computer system hosting or running the computer program can be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that any electronic device capable of executing the above-described functions may perform those functions enumerated above.

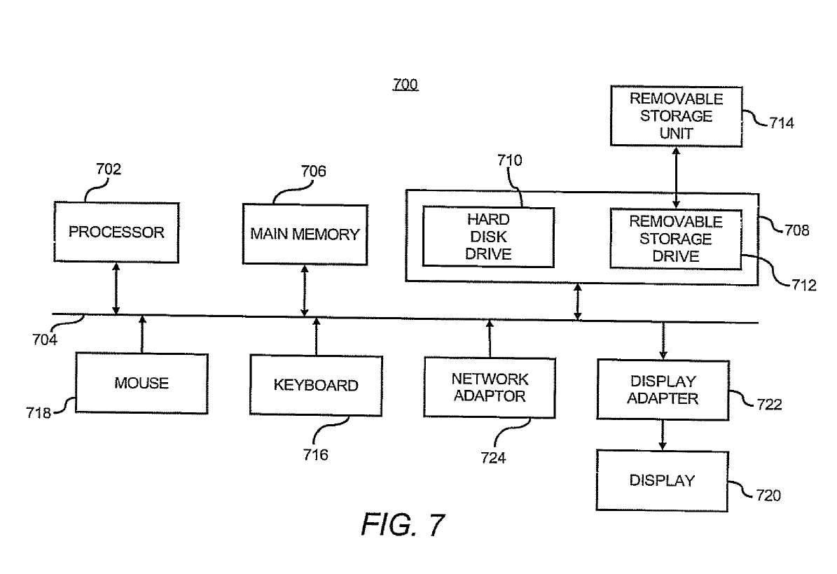

FIG. 7 is illustrative of a general purpose computer system 700, which may be employed to perform the various functions of the controller 510 described hereinabove. In this respect, the computer system 700 may be used as a platform for executing one or more of the functions described hereinabove with respect to the controller 510.

The computer system 700 includes a processor 702, which may be used to execute some or all of the steps described in the method 600. Commands and data from the processor 702 are communicated over a communication bus 704. The computer system 700 also includes a main memory 706, such as a random access memory (RAM), where the program code for, for instance, the controller 510, may be executed during runtime, and a secondary memory 708. The secondary memory 708 includes, for example, one or more hard disk drives 710 and/or a removable storage drive 712, representing a floppy diskette drive, a magnetic tape drive, a compact disk drive, etc.

The removable storage drive 710 reads from and/or writes to a removable storage unit 714 in a well-known manner. User input and output devices may include a keyboard 716, a mouse 718, and a display 720. A display adaptor 722 may interface with the communication bus 704 and the display 720 and may receive display data from the processor 702 and convert the display data into display commands for the display 720. In addition, the processor 702 may communicate over a network, for instance, the Internet, LAN, etc., through a network adaptor 724.

It will be apparent to one of ordinary skill in the art that other known electronic components may be added or substituted in the computer system 700. In addition, the computer system 700 may include a system board or blade used in a rack in a data center, a conventional “white box” server or computing device, etc. Also, one or more of the components in FIG. 7 may be optional (for instance, user input devices, secondary memory, etc.).

While the embodiments have been described with reference to examples, those skilled in the art will be able to make various modifications to the described embodiments without departing from the true spirit and scope. The terms and descriptions used herein are set forth by way of illustration only and are not meant as limitations. In particular, although the methods have been described by examples, steps of the methods may be performed in different orders than illustrated or simultaneously. Those skilled in the art will recognize that these and other variations are possible within the spirit and scope as defined in the following claims and their equivalents.

What is claimed is:

1. A method for managing a blackout of media content data, said method comprising:
receiving a media content stream at a local media content device, wherein the media content stream includes the media content data and blackout data related to the blackout of the media content data, wherein the blackout data is embedded in an elementary stream within the media content stream;
wherein the local media content device is operable to implement blackout of the media content data based upon the blackout data in the media content stream.

2. The method of claim 1, wherein the local media content device is assigned local information, said method further comprising:
comparing the blackout data in the media content stream to the local information; and
determining whether to implement blackout of the media content data based upon the comparison of the blackout data in the media content stream and the local information.

3. The method of claim 2, wherein the blackout data comprises geographical information and the local information comprises geographical information, wherein comparing the blackout data in the media content stream to the local information further comprises:
comparing the geographical information of the blackout data to the geographical information of the local information; and
implementing the blackout of the media content data in response to the blackout data substantially matching the geographical information.

4. The method of claim 2, further comprising:
in response to a determination that a blackout is not to be implemented, transmitting the media content stream containing the media content data from the local media content device.

5. The method of claim 1, wherein the blackout data includes timing information, the method further comprising:
retrieving the timing information from the blackout data in the media content stream, wherein the timing information provides at least an indication of the start time for applying the blackout of the media content data in the media content stream.

6. The method of claim 1, wherein the blackout data comprises a media content ID, said method further comprising:
retrieving the media content ID from the blackout data, wherein the media content ID includes an alias for substitute media content to be transmitted in lieu of the media content data in the media content stream;
querying a directory with the media content ID;
receiving the substitute media content configuration data in response to the querying of the directory; and
transmitting the substitute media content in lieu of the media content data in the media content stream.

7. The method of claim 1, further comprising:
generating an audit report, wherein the audit report includes a record of actions taken in response to the receiving of the media content stream.

8. The method of claim 7, further comprising:
transmitting the audit report in an encrypted message.

9. A method of managing a blackout of media content data, said method comprising:
inserting blackout data into a media content stream containing the media content data, said media content stream comprising an elementary stream, wherein the blackout data is embedded in the elementary stream and associated with the blackout of the media content data, and
wherein a local media content device is operable to implement the blackout of the media content data in response to receiving the blackout data in the media content stream.

10. The method of claim 9, wherein inserting the blackout data into the media content stream further comprises:
inserting the blackout data into the media content stream by a programmer.

11. The method of claim 9, wherein inserting the blackout data into the media content stream further comprises:
inserting the blackout data into the media content stream at a multiple service operator (MSO) network.

12. The method of claim 9, further comprising:
transmitting the media content stream containing the blackout data.

13. A local media content device for managing a blackout of media content data comprising:
a controller for receiving a media content stream, wherein the media content stream contains the media content data and blackout data, wherein the blackout data is embedded in an elementary stream within the media content stream for implementing the blackout of the media content data, wherein the local media content device is operable to implement the blackout of the media content data based upon the blackout data contained in the media content stream.

14. The local media content device of claim 13, wherein the blackout data further comprises:
geographical information, wherein the controller is operable to implement the geographical information in making a blackout implementation determination.

15. The local media content device of claim 13, wherein the media content stream further comprises:
timing information, wherein the timing information at least includes a start time to implement the blackout of the media content data;
wherein the controller is configured to implement the timing information in determining when to implement the blackout.

16. The local media content device of claim 13, wherein the media content stream further comprises:
a media content ID, wherein the media content ID includes an alias for substitute media content to be transmitted in lieu of the media content data in the media content stream;
wherein the controller is further configured to retrieve the media content ID in response to a determination that a blackout is to be implemented.

17. The local media content device of claim 16, wherein the controller is further operable to query a directory containing substitute media content configuration data corresponding to the media content ID, and wherein the controller is further configured to transmit the substitute media content to at least one user.

18. The local media content device according to claim 13, wherein the controller is further configured to generate an audit report in response to a blackout implementation, said controller being further configured to transmit the audit report to at least one other device.

19. A computer readable storage medium on which is embedded one or more computer programs comprising a set of instructions that when executed by a processing circuit performs a method of managing a blackout of media content data, said set of instructions comprising:
receiving a media content stream at a local media content device, wherein the media content stream includes the media content data and blackout data related to the blackout of the media content data, wherein the blackout data is embedded in an elementary stream within the media content stream,
wherein the local media content device is operable to implement blackout of the media content data based upon the blackout data in the media content stream.

20. The computer readable storage medium according to claim 19, wherein the local media content device is assigned local information, said one or more computer programs further comprising a set of instructions for:
comparing the blackout data in the media content stream to the local information; and
determining whether to implement the blackout of the media content data based upon the comparison of the blackout data in the media content stream and the local information.

21. The computer readable storage medium according to claim 19, wherein the blackout data comprises geographical information and the local information comprises geographical information, said one or more computer programs further comprising a set of instructions for:
comparing the geographical information of the blackout data to the geographical information of the local information; and
blacking out the media content data in response to the comparison.

22. The computer readable storage medium according to claim 19, wherein the blackout data includes timing information, said one or more computer programs further comprising a set of instructions for
retrieving the timing information from the blackout data in the media content stream, wherein the timing information provides an indication of the start time for applying the blackout of the media content data in the media content stream; and
implementing the blackout according to the timing information.
